(19) United States
(12) Patent Application Publication
(10) Pub. No.: US 2014/0061195 A1
(43) Pub. Date: Mar. 6, 2014

(54) PACKAGING CONTAINER

(71) Applicant: Daisuke Sagawa, Tokyo (JP)

(72) Inventor: Daisuke Sagawa, Tokyo (JP)

(73) Assignee: TETRA LAVAL HOLDINGS & FINANCE S.A., Pully (CH)

(21) Appl. No.: 13/996,413

(22) PCT Filed: Dec. 19, 2011
(86) PCT No.: PCT/JP2011/079362

§ 371 Date: Nov. 12, 2013

(30) Foreign Application Priority Data
Dec. 20, 2010 (JP) 2010-283230

(51) Int. Cl. B67D 7/00

(52) U.S. Cl. CPC B67D 7/005
USPC 220/260; 220/825

(57) ABSTRACT

Provided is a packaging container having a smaller environmental load compared to a container having a plastic cap/spout, capable of opening/re-closing of the container by a simple and inexpensive structure, and capable of easily pouring its content. The packaging container may include an opening and a spout provided on a top wall, wherein the spout is formed with a folded spout panel. The spout panel may comprise a flow-path panel which covers the opening and forms a pouring flow path; two side wall panels which are adjacent to both sides of the flow-path panel and form side walls of the flow path; a lower end sealing panel which is adjacent to the lower end of the flow-path panel to connect the lower end of the spout to the container wall; and two side sealing panels respectively adjacent to the lower ends of the side wall panels to connect the sides of the spout to the top wall: and wherein the spout panel is formed by connecting the lower end sealing panel to the container wall at the lower side of the opening, connecting the side sealing panels to the top wall at the sides of the opening, and folding the side wall panels at respective centers so that the flow-path panel covers the opening.

### CROSS REFERENCE TO RELATED APPLICATIONS

This application is a national phase application based on PCT/JP2011/079362, filed Dec. 19, 2011, which claims the priority of Japanese Patent Application No. 20100283230, filed Dec. 20, 2010, the content of both of which is incorporated herein by reference.

### BACKGROUND

The present invention relates to a packaging container with a spout configured to be filled with cow's milk, juices, alcoholic drinks, mineral water, green tea, and the like.

A laminated material made of paper having rich flexibility has been used for packaging of liquid foods over many years. The packaging container 20 as shown in FIG. 14 (A), for example, may be configured for cow's milk, juices, sake, white distilled liquor, mineral water, and other beverages. Such a container may comprise a web-like package laminated material that is formed of fiber base materials (e.g. paper.) The package laminated material may include a plastic laminate having crease lines formed into a tube shape by a longitudinal seal. The tube shape may be filled up with content (e.g. cow's milk, juices, sake, white distilled liquor, mineral water, etc.) and transversally sealed in a transverse direction of the tube shaped packaging material. Additionally, packaging container 20 may be formed into a cushion or pillow shaped packaging body (primary shape container). The pillow shaped packaging body may be within each container 20 in the transversal seal portion, and may be folded up to mountain folds and valley folds along creasing lines with fins 21 and flaps 22. Container 20 may include a gable-top shaped top wall, as shown in FIG. 14 (B), formed by another folding of the fins 21 and the flaps 22 in the final folding step. In the final folding step, container 20 may have a shed roof shaped top wall, as shown in FIG. 14 (C), formed by the other folding of the fins 21 and the flaps 22.

A gable-top shaped (gable roof like) paper packaging container 20 may be obtained by cutting the paper packaging material into the predetermined shape, obtaining blanks sealed to the container in a lengthwise direction, after bottom sealing of the blanks in a filling machine. Packaging container 20 may be filled with cow's milk, juices, or other beverages from an upper opening, and then sealed. Various designs or products may be printed on the surface of the packaging materials.

A spout may be formed in container 20 by a method of first forming a spout closure and then sealing the spout to container 20, or to the packaging material. The spout may be formed before forming a pouring hole punched on container 20, or its packaging material. The spout may be inserted from the inside of the pouring hole for attachment to container 20, and may be secured to container 20 with an ultrasonic seal, hot melt, heat sealing, etc. Alternatively, the spout may be formed in container 20 by a method of directly forming the spout closure onto the pouring hole punched on the packaging material for paper containers. This method may include injection molding, forming the container from the packaging material, and punching an opening on the container top wall. The method may further include heat sealing the outside with an inner tape and the inside with a pull tab film 23, and forming the spout 24, as shown in FIG. 14 (A).

### SUMMARY OF THE DISCLOSED EMBODIMENTS

The present disclosure provides a packaging container having a smaller environmental load compared to a container having a plastic cap/spout. The packaging container is capable of opening/re-closing by a simple and inexpensive structure and allows for easy pouring of its contents.

The packaging container of the present disclosure may be formed from a tube comprised of web-like packaging material. The tube may be longitudinally sealed and filled with liquid products. Additionally, the tube may be sealed in a transverse direction of the tube shaped packaging material, forming a pillowy packaging body. Individual pillowy packaging bodies may be cut. Folding along the crease lines may form a top wall, side walls and a bottom wall, and attaching fins and flaps which are formed to the above-mentioned walls may form a final shape, which may include an opening and a spout provided on the opening on the top wall. The spout may be formed with a folded spout panel, the spout panel comprising a flow-path panel which covers the opening and forms a pouring flow path; two side wall panels which are adjacent to both sides of the flow-path panel and form side walls of the flow path; a lower end sealing panel which is adjacent to the lower end of the flow-path panel to connect the lower end of the spout to the container wall; and two side sealing panels respectively adjacent to the lower ends of the side wall panels to connect the sides of the spout to the top wall. The spout may be formed by connecting the lower end sealing panel to the container wall at the lower side of the opening, connecting the side sealing panels to the top wall at the sides of the opening, and folding the side wall panels at respective centers so that the flow-path panel covers the opening.

In some embodiments, the flow-path panel may be provided with a flow-path assist panel which has a larger tilt angle at the time of pouring than a tilt angle of the flow-path panel in the upper end, and the flow-path assist panel may be latched by the folded fin at the time of re-closing.

The flow-path panel may be provided with the at least two crease lines that extend from both lower ends towards the central upper end, and the flow-path panel may have a V-shaped section at the time of pouring.

In some embodiments, the flow-path panel seals the opening from above, an inner tape seals the opening from underneath, and the undersurface of the flow-path panel and the inner tape are sealed within the opening so that the opening of the container is sealed.

Additionally, the flow-path panel may cover a pull tab film from above. The pull tab film may seal the opening from underneath, an inner tape may seal the opening from underneath, and the pull tab film and the inner tape may be sealed within the opening so that the opening of the container is sealed.

According to the present disclosure, the following effects and functions are shown, and the advantageous effect is acquired.

The packaging container of the present disclosure may be obtained by tube forming by longitudinal sealing of the web-like packaging material, filling of liquid products into the tube shaped packaging material, transversal sealing to the transverse direction of the tube shaped packaging material, forming of pillowy packaging bodies, individual cutting of the pillowy packaging bodies, folding up along the crease lines to form the top wall, side walls and the bottom wall, and attaching fins and flaps which are formed to the above-mentioned walls to form to the final shape, and has the opening and the spout provided on the opening on the top wall. The spout may be formed from the folded-up spout panel. Since the fin and the flaps may be formed on the side wall and the top wall of the packaging container, the spout may be formed by folding up the panel. The panel, or the piece of the panel, can be hooked and used as a latch portion for sealing and re-closing. The web-like packaging material of the container may include paper material. When the same paper material is used for the tube as for the panel of the spout, the environmental impact may be reduced and the waste may be easily segregated at the recovery.

The spout panel may comprise the flow-path panel which covers the opening and forms the pouring flow path, two side wall panels which are adjacent to both sides of the flow-path panel and form side walls of the flow path, the lower end sealing panel which is adjacent to the lower end of the flow-path panel to connect the lower end of the spout to the container wall, and two side sealing panels respectively adjacent to the lower ends of the side wall panels to connect the sides of the spout to the top wall. The spout panel may be formed by connecting the lower end sealing panel to the container wall at the lower side of the opening, connecting the side sealing panels to the top wall at the sides of the opening, and folding the side wall panels at respective centers so that the flow-path panel covers the opening. When using the spout, the upper part or the upper end of the flow-path panel may be grasped and raised, and the cover (flow-path panel) on the opening may be taken and pulled up. Simultaneously, flatly folded side wall panels may extend and rise. When the flow-path panel is pulled up, the side wall panels may form the side wall of the flow path, and the flow path is formed. The lower end sealing panel seals the lower end of the flow-path panel, and the side sealing panel seals the lower part of the side wall panel to the top wall, and the required seal is obtained.

In some embodiments, the flow-path panel may be provided with the flow-path assist panel which has the larger tilt angle at the time of pouring than the tilt angle of the flow-path panel in the upper end. The flow-path assist panel may be latched by the folded fin at the time of re-closing. The liquid contents may be poured without any turbulent flow through the flow-path assist panel from the flow-path panel at the time of pouring, since the flow-path assist panel has the larger tilt angle at the time of pouring than the tilt angle of the flow-path panel. The opening may be covered by the flow-path panel, since the flow-path assist panel is latched by the folded fin at the time of re-closing.

The flow-path panel may be provided with the at least two crease lines extending from both lower ends towards the central upper end. The flow-path panel may have a V-shaped section formed at the time of pouring. The two crease lines can be folded and the flow-path panel can be formed to the V-shaped section at the time of pouring, and the contents can be poured in order, without splattering.

In some embodiments, the flow-path panel seals the opening from above, the inner tape seals the opening from underneath, the undersurface of the flow-path panel and the inner tape are sealed within the opening so that the opening of the container is sealed. Since the undersurface of the flow-path panel and the inner tape are sealed within the opening, unsealing becomes possible by one action of pulling up the flow-path panel at the time of unsealing.

In other embodiments, the flow-path panel covers the pull tab film from above, the pull tab film seals the opening from underneath, the inner tape seals the opening from underneath, and the pull tab film and the inner tape are sealed within the opening so that the opening of the container is sealed. Since the flow-path panel covers the seal top of the pull tab, the comparatively/mechanically weak spout may be protected, and the container may be reliable. As mentioned above, by using panels of paper, the packaging container may have a smaller environmental load compared to a container having a plastic cap/spout, may be capable of opening/re-closing of the container by a simple and inexpensive structure, and may be capable of easily pouring its contents.

### BRIEF DESCRIPTION OF THE DRAWINGS

FIG. 1 is a partial perspective view at the time of pouring according to a first exemplary packaging container;

FIG. 2 is a partial perspective view at the time of sealing according to the first exemplary packaging container;

FIG. 3 is an illustration of a spout panel according to the first exemplary packaging container;

FIG. 4 is a partial perspective view at the time of sealing according to a second exemplary packaging container;

FIG. 5 is a partial perspective view at the time of pouring according to the second exemplary packaging container;

FIG. 6 is a partial perspective view at the time of sealing according to a third exemplary packaging container;

FIG. 7 is a partial perspective view at the time of re-closing according to the third exemplary packaging container;

FIG. 8 is a partial perspective view at the time of sealing according to a fourth exemplary packaging container;

FIG. 9 is a partial perspective view at the time of pouring according to the fourth exemplary packaging container;

FIG. 10 is a partial perspective view at the time of re-closing according to the fourth exemplary packaging container;

FIG. 11 is an illustration of a spout panel according to the fourth exemplary packaging container;

FIG. 12 is an illustration showing section views according to a first exemplary unsealing method;

FIG. 13 is an illustration showing section views according to a second exemplary unsealing method;

FIG. 14(A) is an illustration showing a brick-like packaging container;

FIG. 14(B) is an illustration showing a gable-top root type container;

FIG. 14(C) is an illustration showing a shed roof type container; and

FIG. 15 is a schematic diagram of a package filling machine.

### DETAILED DESCRIPTION

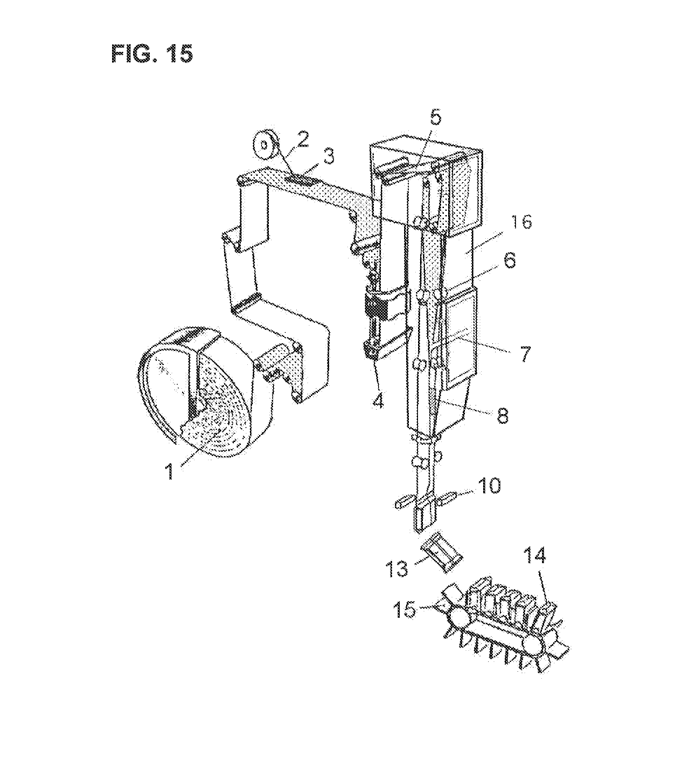

Hereinafter, the details are explained, referring to the drawings for the embodiment of the invention. As shown in FIG. 15, the web-like package laminated material 1 may be taken in the package filling machine with a reel. The package laminated material 1 may comprise a flexible laminate of paper substrate and polyethylene resin, wherein the paper substrate is laminated on both sides. Barrier layers such as aluminum foil may be formed between the paper substrate and the film. Additionally, an exterior surface of the paper substrate, corresponding to the surface of the packaging container, may be printed on before the paper substrate is disposed on the reel. The spout panel may include paper or plastics base material, the thermoplastic resin inner layer and outer layer, and, if needed, barrier layers.

With a transportation means, the package laminated material 1 is conveyed continuously on the package filling machine. The package laminated material 1 is fed to a strip applicator 3, and a strip 2 is formed along one edge of the package laminated material 1 by the strip applicator 3. The package laminated material 1 may be fed to a sterilization bath 4, and sterilized with sterilization liquid, such as the hydrogen peroxide, in the sterilization bath 4. The package laminated material 1 may also be fed to an aseptic chamber 16, after being fed to an air knife and dried by the air knife. The package laminated material 1 may be gradually deformed by forming rings 6, and made into a tube shape.

A longitudinal seal of the edge sections of the package laminated material 1, formed by the tube shape, may be pressed and carried out with the strip 2 with the longitudinal seal apparatus 8. The filling pipe 7 may fill up with flow/liquid food and supply the flow/liquid food to the tube shape package laminated material 1. The tube shape package laminated material may be guided with rollers and transversally sealed with the transversal seal apparatus 10 in the transverse direction. The transversally sealed package laminated material may be cut with a knife, for example, and form the pillowy packaging body 13. The pillowy packaging body 13 may be formed with the final folding equipment 15 into the final shape, and the packaging container 14 may include the fluid food product.

The spout of the packaging container may be formed inside the above-mentioned package filling machine, outside and downstream the machine in the above-mentioned package filling machine, or outside and upstream the machine of the above-mentioned package filling machine. As shown in FIG. 12 (A), the openings of the top wall may be punched and the inner tape 32 may be applied inside the above-mentioned machine. The spout 30 of the folded-up spout panel may be heat sealed to the opening 31. As shown in FIG. 13 (A), the openings of the top wall may be punched and the inner tape 32 and pull tab film 33 may be applied and sealed inside the above-mentioned machine. The spout 30 of the folded-up spout panel may be provided by covering the opening 31 sealed with the pull tab 33 and by sealing to the neighborhood. In other embodiments, the openings of the top wall may be punched and the plastic layer laminated in the packaging material manufacturing step in the upper stream of the package filling machine. The spout 30 of the folded-up spout panel, as shown in FIG. 12 (A), may be provided by heat sealing to the opening 31 or by covering the sealed opening and by sealing to the neighborhood.

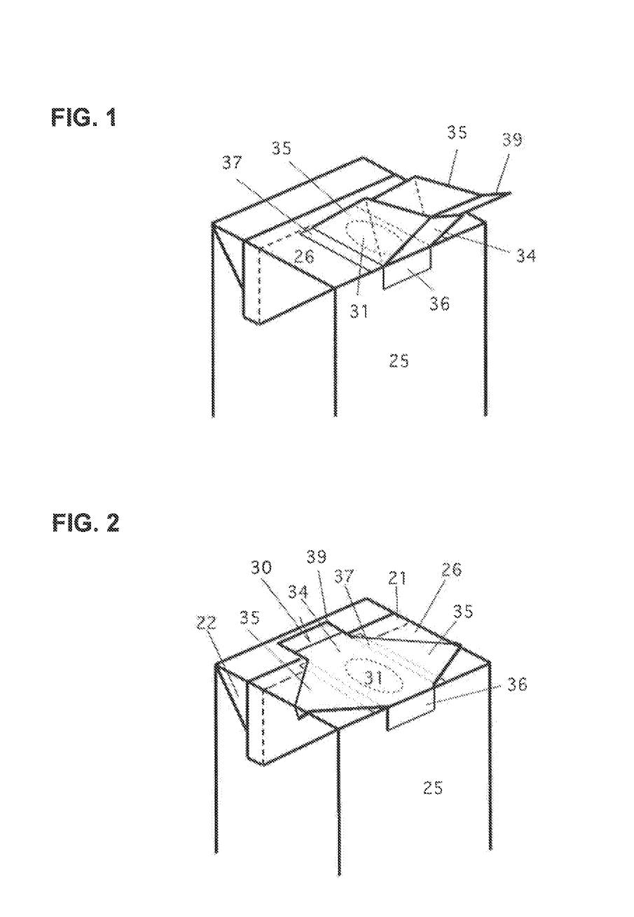

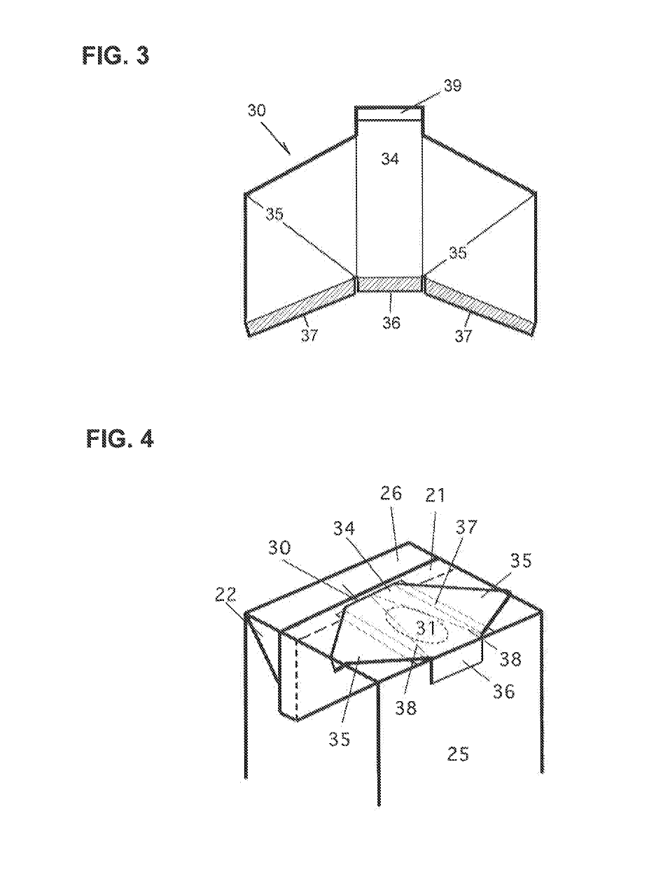

In the embodiment shown in FIG. 1, FIG. 2, and FIG. 3, the spout panel 30 may comprise the flow-path panel 34 which covers the opening and forms the pouring flow path, two side wall panels 35 and 35 which are adjacent to both sides of the flow-path panel 34 and form side walls of the flow path, the lower end sealing panel 36 which is adjacent to the lower end of the flow-path panel 34 to connect the lower end of the spout to the container wall, and two side sealing panels 37 and 37 respectively adjacent to the lower ends of the side wall panels 35 to connect the sides of the spout to the top wall. As shown in FIG. 2, the spout panel 30 may be formed by connecting the lower end sealing panel 36 to the container wall 25 at the lower side of the opening 31, connecting the side sealing panels 37 and 37 to the top wall 26 at the sides of the opening 31, and folding the side wall panels 35 at respective centers so that the flow-path panel 34 covers the opening 31. When using of the spout, as shown in FIG. 1, the upper part or the upper end of the flow-path panel 34 is grasped and raised, and the cover (flow-path panel) on the opening 31 is taken and pulled up. Simultaneously, flatly folded side wall panels 35 and 35 extend and rise. When the flow-path panel 34 is pulled up, the side wall panels 35 and 35 form the side wall of the flow path. The lower end sealing panel 36 seals the lower end of the flow-path panel 34, and the side sealing panel 37 seals the lower part of the side wall panel 35 to the top wall 26, and the required seal is obtained.

The flow-path panel may be provided with the flow-path assist panel 39 which has the larger tilt angle at the time of pouring than the tilt angle of the flow-path panel in the upper end, and the flow-path assist panel is latched by the folded fin at the time of re-closing. The liquid contents may be poured without any turbulent flow through the flow-path assist panel 39 from the flow-path panel at the time of pouring, since the flow-path assist panel has the larger tilt angle at the time of pouring than the tilt angle of the flow-path panel. The opening may be covered by the flow-path panel, since the flow-path assist panel is latched by the folded fin at the time of re-closing.

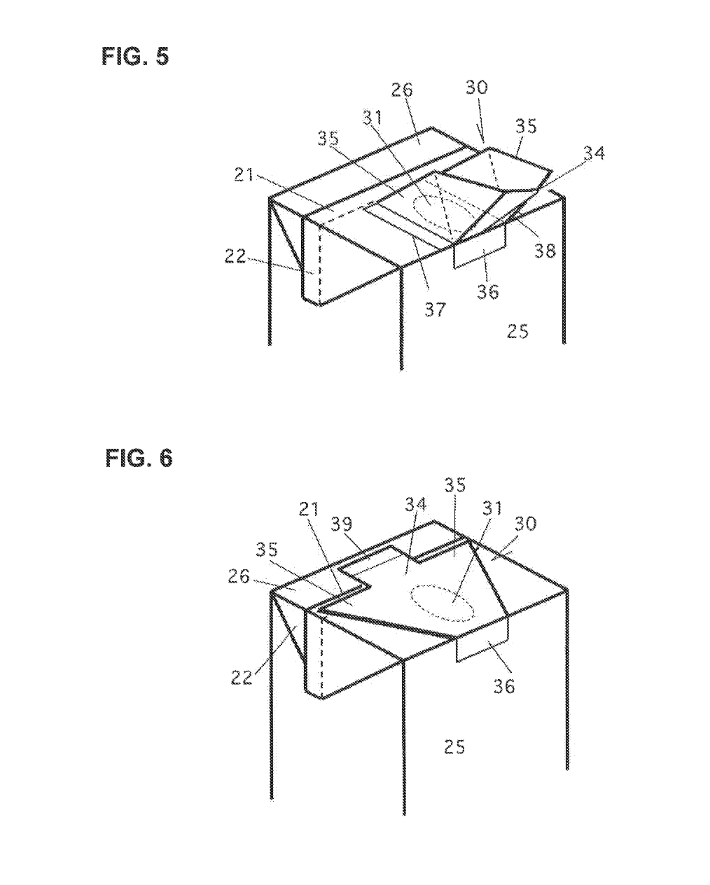

As shown in FIG. 4 and FIG. 5, the spout panel 30 may be formed by connecting the lower end sealing panel 36 to the container wall 25 at the lower side of the opening 31, connecting the side sealing panels 37 and 37 to the top wall 26 at the sides of the opening 31, and folding the side wall panels 35 at respective centers so that the flow-path panel 34 covers the opening 31. As shown in FIG. 4, when using of the spout, the upper part or the upper end of the flow-path panel 34 is grasped and raised, and the cover (flow-path panel) on the opening 31 is taken and pulled up. Simultaneously, flatly folded side wall panels 35 and 35 extend and rise. When the flow-path panel 34 is pulled up, the side wall panels 35 and 35 form the side wall of the flow path. The lower end sealing panel 36 seals the lower end of the flow-path panel 34, and the side sealing panel 37 seals the lower part of the side wall panel 35 to the top wall 26, and the required seal is obtained.

The flow-path panel 34 may be provided with two crease lines 38 that extend from both lower ends and towards the central upper end. The flow-path panel may have a V-shaped section formed at the time of pouring. The two crease lines 38 are folded and the flow-path panel can be formed to the V-shaped section at the time of pouring, and the contents can be poured in order, without splattering.

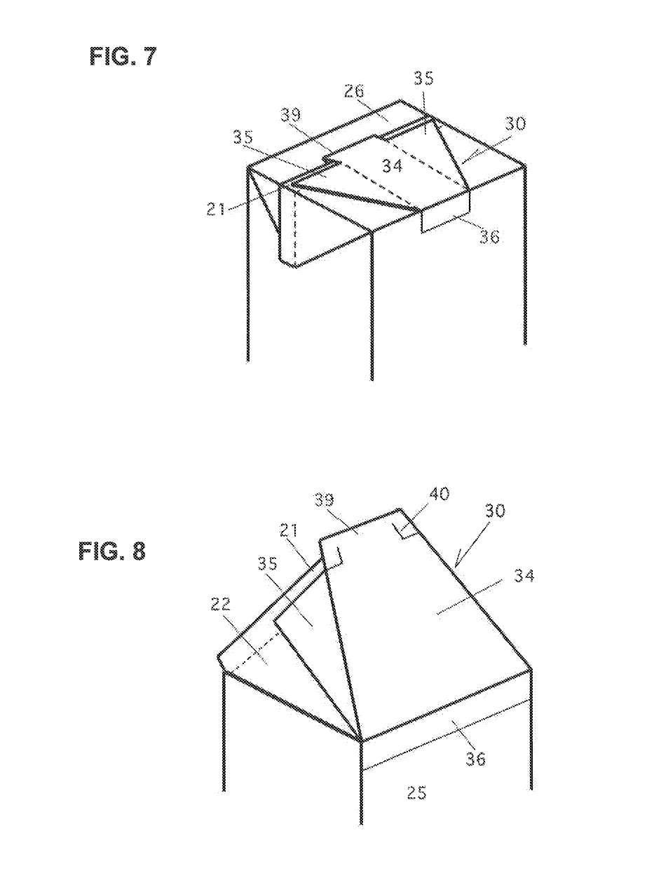

As shown in FIG. 6 and FIG. 7, the spout panel 30 may be formed by connecting the lower end sealing panel 36 to the container wall 25 at the lower side of the opening 31, connecting the side sealing panels 37 and 37 to the top wall 26 at the sides of the opening 31, and folding the side wall panels 35 at respective centers so that the flow-path panel 34 covers the opening 31. When using of the spout, the upper part or the upper end of the flow-path panel 34 is grasped and raised, and the cover (flow-path panel) on the opening 31 is taken and pulled up. Simultaneously, flatly folded side wall panels 35 and 35 extend and rise. When the flow-path panel 34 is pulled up, the side wall panels 35 and 35 form the side wall of the flow path.

Since the flow-path panel is provided with the flow-path assist panel 39, and the flow-path assist panel 39 is latched, as shown in FIG. 7, by the folded fin 21 at the time of re-closing, the opening 31 may be covered by the flow-path panel 34.

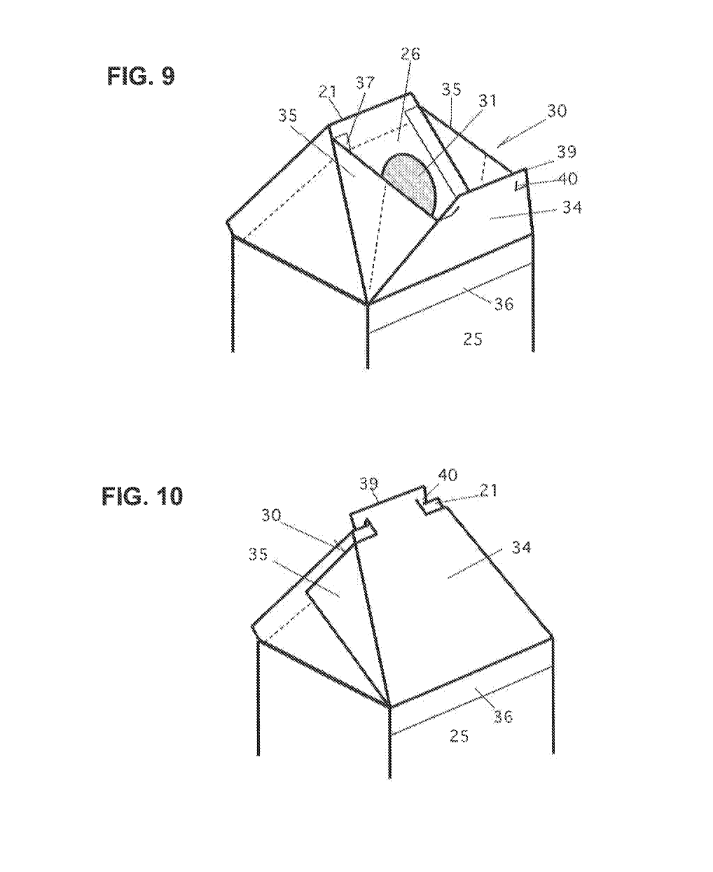

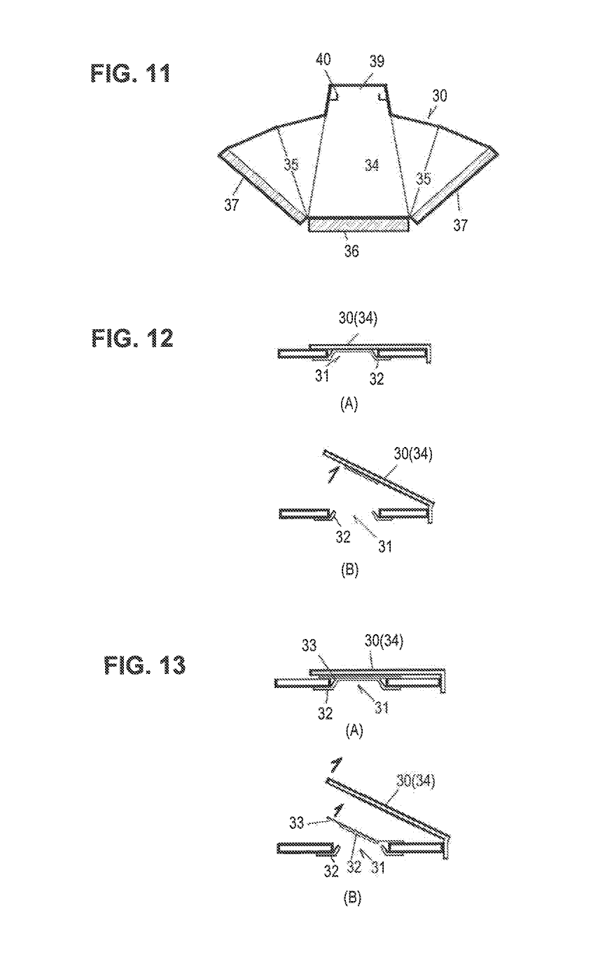

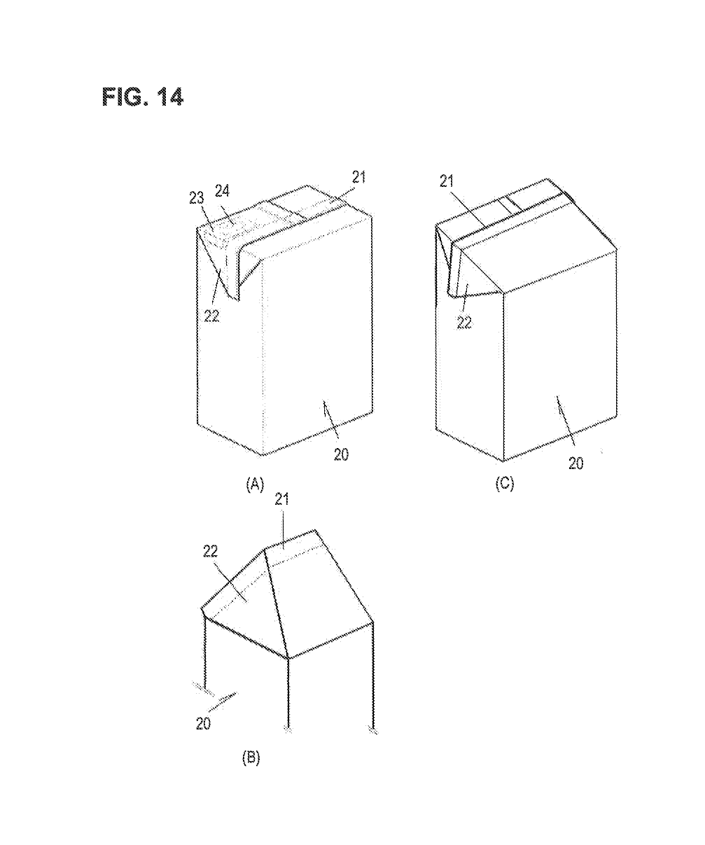

As shown in FIG. 8, FIG. 9, and FIG. 10, the spout panel 30 may comprise the flow-path panel 34 which covers the opening and forms the pouring flow path, two side wall panels 35 and 35 which are adjacent to both sides of the flow-path panel 34 and form side walls of the flow path, the lower end sealing panel 36 which is adjacent to the lower end of the flow-path panel 34 to connect the lower end of the spout to the container wall, and two side sealing panels 37 and 37 respectively adjacent to the lower ends of the side wall panels 35 to connect the sides of the spout to the top wall. As shown in FIG. 8, the spout panel 30 may be formed by connecting the lower end sealing panel 36 to the container wall 25 at the lower side of the opening 31, connecting the side sealing panels 37 and 37 to the top wall 26 at the sides of the opening 31, and folding the side wall panels 35 at respective centers so that the flow-path panel 34 covers the opening 31. As shown in FIG. 9, when using of the spout, the upper part of the flow-path panel 34 and the portion of the flow-path assist panel 39 is grasped and raised, and the cover (flow-path panel) on the opening 31 is taken and pulled up. Simultaneously, flatly folded side wall panels 35 and 35 extend and rise. When the flow-path panel 34 is pulled up, the side wall panels 35 and 35 form the side wall of the flow path, and the flow path is also formed. The lower end sealing panel 36 seals the lower end of the flow-path panel 34, and the side sealing panel 37 seals the lower part of the side wall panel 35 to the top wall 26, and the required seal is obtained.

Since the flow-path panel is provided with the flow-path assist panel 39, and the flow-path assist panel 39 is latched, as shown in FIG. 10, by the folded fin 21 at the time of re-closing, the opening 31 may be covered by the flow-path panel 34.

As shown in FIG. 12 (A), the flow-path panel 34 seals the opening 31 from above, the inner tape 32 seals the opening 31 from underneath, the undersurface of the flow-path panel 34 and the inner tape 31 are sealed within the opening 31 so that the opening 31 of the container is sealed. Since the undersurface of the flow-path panel 34 and the inner tape 32 are sealed within the opening, unsealing may be possible by one action of the pulling up the flow-path panel at the time of unsealing. When unsealing at the usage of the spout, the upper part or the portion of the upper end of the flow-path panel 34 may be grasped and raised, the cover (flow-path panel) on the opening 31 may be taken, as shown in FIG. 12, (B), and then the inner tape may also be pulled, causing the thin and weak inner tape to break.

As shown in FIG. 13 (A), the flow-path panel 34 covers the pull tab film 33 from above, the pull tab film 33 seals the opening 31 from underneath, the inner tape 32 seals the opening 31 from underneath, and the pull tab film 33 and the inner tape 32 are sealed within the opening so that the opening of the container is sealed. Since the flow-path panel 34 covers the seal top of the pull tab 33, the comparatively/mechanically weak neighborhood of the spout 30 may be protected, and the container may be considered reliable. When unsealing at the usage of the spout, the upper part or the portion of the upper end of the flow-path panel 34 may be grasped and raised, furthermore the pull tab film 33 may be raised, the cover (flow-path panel) on the opening 31 may be taken, as shown in FIG. 13 (B), and then the inner tape 32 may also be pulled, causing the thin and weak inner tape 32 to break.

The present disclosure is not limited to the disclosed embodiments, and other embodiments will be apparent to those skilled in the art from consideration of the specification and practice of the disclosed embodiments disclosed herein.

This invention is applicable to manufacturing of packaging and filling of the liquid foods.

1. A packaging container, comprising:
a tube formed of a web-like packaging material and configured to be filled with liquid products; and
an opening and a spout disposed on a top wall of the tube,
wherein the spout is formed with a folded spout panel, the spout panel comprising:
a flow-path panel which covers the opening and forms a pouring flow path;
two side wall panels that are adjacent to both sides of the flow-path panel and that form side walls of the flow path;
a lower end sealing panel that is adjacent to a lower end of the flow-path panel and that connects a lower end of the spout to the tube wall; and
two side sealing panels respectively adjacent to the lower ends of the side wall panels that connect the sides of the spout to the top wall; and
wherein the spout panel is formed by connecting the lower end sealing panel to the tube wall at a lower side of the opening, connecting the side sealing panels to the top wall at the sides of the opening, and folding the side wall panels at respective centers so that the flow-path panel covers the opening.

2. The packaging container according to claim 1, wherein the flow-path panel is provided with a flow-path assist panel which has a larger tilt angle at the time of pouring than a tilt angle of the flow-path panel in the upper end, and the flow-path assist panel is latched by a folded fin at the time of re-closing.

3. The packaging container according to claim 1, wherein the flow-path panel is provided with at least two crease lines extending from the lower ends towards the central upper end, and the flow-path panel having a V-shaped section at the time of pouring.

4. The packaging container according to claim 1, wherein the flow-path panel seals the opening from above, an inner tape seals the opening from underneath, and the undersurface of the flow-path panel and the inner tape are sealed within the opening so that the opening of the container is sealed.

5. The packaging container according to claim 1, wherein the flow-path panel covers a pull tab film from above, the pull tab film seals the opening from underneath, an inner tape seals the opening from underneath, and the pull tab film and the inner tape are sealed within the opening so that the opening of the container is sealed.

6. The packaging container according to claim 1, wherein the web-like packaging material is a laminate containing a paper substrate, and the spout panel is formed of a laminate material containing the paper substrate.
